(19) United States
(12) Patent Application Publication
(10) Pub. No.: US 2011/0155881 A1
(43) Pub. Date: Jun. 30, 2011

(54) DISPENSER HOOK

(76) Inventors: Carlos REYES, Meadow Vista, CA (US); Heather MACKINNON, Bend, OR (US)

(21) Appl. No.: 12/647,695

(22) Filed: Dec. 28, 2009

(51) Int. Cl. F16B 45/00; A01M 1/20

(52) U.S. Cl. 248/304; 43/131

(57) ABSTRACT

A dispenser hook for dispensing chemicals and configured to hang on supports. The dispenser hook is designed to withstand the forces applied by a mechanical harvester. The dispenser hook is configured to couple with a dispenser. The dispenser hook has a hook body with a resiliently flexible outer leg and an inner leg, such that the two legs form a gate to an interior opening within the hook.

### BACKGROUND OF THE INVENTION

1. Field of the Invention

The disclosure set forth herein pertains to the field of pest control. More particularly, but not by way of limitation, the disclosure is directed to a dispenser hook with an attached dispenser, particularly for use in agricultural settings.

2. Description of the Related Art

As an alternative or adjunct to spray chemical treatments in a field, chemical dispensers are used for pest control. Chemical dispenser devices may include a hook configured to hang from a structure, such as a small branch, wire, or other structure. The hook is attached to a chemical dispenser which dispenses a chemical, such as an insecticide or a pheromone. The chemical dispenser may contain chemicals such as insecticides for pest control or pheromones for mating disruption.

Large-scale mechanical operations have become a common agricultural technique at many stages, including planting, maintenance and harvesting. Although mechanical operations increase efficiency, they also pose unique problems which are absent in manual operations. For example, mechanical operations can exert stronger forces on plants and supporting structures to achieve a goal, such as releasing a harvestable crop from a plant. Mechanical harvesters also have difficulty identifying and separating the harvestable crop from other components it identifies in the field. For example a mechanical harvester ideally separates the harvestable crop from dirt, leaves, branches, stems, immature crop, and agricultural devices in the field, such as hanging chemical dispensers.

For example, plants in a vineyard are grown in rows on a network of trellis wire. A variety of trellis wire configurations are commonly used. The most popular size for vineyard trellis wire is 12.5 gauge. To harvest the crop, a mechanical harvester moves along one or more rows of grape vines supported by trellis wire. The trellis wire may also support devices designed to attach to wire, including pest control devices. Such devices include a hook configured to hang from the trellis wire. The hook is attached to a chemical dispenser which dispenses a chemical, such as an insecticide or a pheromone. When the device is deployed in a grape vineyard, the dispenser may include an insecticide, pheromone or other compound effective on the vine mealybug.

Loss of the hanging devices is a problem because the devices are not able to tolerate the forces exerted during various harvesting and maintenance operations. If the hanging device is removed by a mechanical machine, such as a machine performing routine maintenance on the field, the hanging device is rendered ineffective. Harvesting machines generate forces which can break the device or shake the device from its support. Detached or broken hanging devices are problematic due to devices and attached dispensers finding their way into the harvested product. Delivering harvested product with chemical dispensers mixed in is problematic because it is considered undesirable by the downstream market. For example, even if the delivered produce is considered safe by a federal regulatory body, an entity receiving the produce may still be concerned about chemical contamination. There are currently no known systems that provide a durable pest control device for dispensing selected chemicals, wherein the pest control device is configured to securely hang on its support despite the forces applied during harvesting and maintenance procedures.

For at least the limitations described above there is a need for a durable dispenser hook for dispensing chemicals that withstands forces such as those applied by a mechanical harvester.

### BRIEF SUMMARY OF THE INVENTION

The disclosure provided here is directed to a dispenser hook for dispensing chemicals such as insecticides for pest control or pheromones for mating disruption. Dispensers are generally attached to the dispenser hooks before the dispenser hook assemblies are deployed in a field on a support, such as a branch, trellis wire, or any other support. The design of the dispenser hook set forth herein is such that it has a high tolerance for the type of forces applied by agricultural machines. Thus, the dispenser hook remains intact and secure even after its support is passed over by a machine.

A dispenser hook assembly includes a dispenser hook and a dispenser attached to the hook. The dispenser hook includes a hook body having a resiliently flexible outer leg and an inner leg, such that the two legs form a gate to an interior opening within the hook. An end of the resiliently flexible outer leg and an end of the inner leg are substantially parallel. At least one dispenser is attached to the hook by an attaching means, such as stitching, a latching mechanism, adhesive, or any other attaching means. The dispenser may include an insecticide, pheromone or other compound. One embodiment of the dispenser hook assembly may be configured for hanging in a vineyard on a trellis wire for vine mealybug mating disruption. The material for the dispenser hook may include synthetic polymer materials such as ABS, polypropylene, or another material that can withstand the force exerted by the harvester. The hook is resiliently flexible in order to enable easy insertion of its support through the gate and also for absorbing the agitative forces of the harvester.

The flexible outer leg and the hook body may join at a support nest within the interior opening. The support nest permits a support entering through the gate to rest within it. This reduces the agitation of the dispenser hook during harvesting, hence providing increased durability of the dispenser hook. The support nest may be a recess along the inner edge of said interior opening or a curved projection extending inward to the dispenser hook. The support may be a wire, a branch, a rope, a rod, or any other support which may fit within the support nest.

The dispenser hook may be provided with a dispenser tab extending from the dispenser hook for attaching the dispenser. The dispenser hook may be further provided with one or more stacking tabs, such as elongated protrusions on the dispenser hook, for stacking the hook onto a machine for attaching the dispenser.

The dispenser hook may further include at least one gate guard, such as a protrusion from the dispenser hook at the gate, such that its support is guarded from exiting out of the interior portion of the gate. The protrusion may be from the inner leg, the outer leg, or both legs.

One or more embodiments of the dispenser hook include a first leg which is resiliently flexible and a more rigid second leg which extend to form a gate. An end of the first leg and an end of the second leg are substantially parallel. A support passes through the gate to an interior opening.

The first leg flexes outward to expand the gate, allowing a support to easily pass through. The first leg may be configured to flex against a support when the dispenser hook is pressed against a support, causing the gate to widen and allow its support to pass through gate.

The first leg may meet a support nest disposed within interior opening. The support nest is generally configured to temporarily change form when the first leg is resiliently flexed outward, allowing a support to enter or leave.

### BRIEF DESCRIPTION OF THE DRAWINGS

The above and other aspects, features and advantages of the disclosure provided here will be more apparent from the following more particular description thereof, presented in conjunction with the following drawings wherein:

FIG. 1 is an illustration of a dispenser hook assembly in accordance with one or more embodiments.

FIG. 2 is an illustration of a dispenser hook in accordance with one or more embodiments.

FIG. 3 is an illustration of a dispenser hook in accordance with one or more embodiments.

FIG. 4 is an illustration of a dispenser hook in accordance with one or more embodiments.

FIG. 5 is an illustration of a dispenser hook described in the prior art.

FIGS. 6A-6D are illustrations of dispenser hooks in accordance with one or more embodiments.

FIG. 7 is an illustration of a dispenser hook in accordance with one or more embodiments.

### DETAILED DESCRIPTION

A dispenser hook will now be described. In the following exemplary description numerous specific details are set forth in order to provide a more thorough understanding of embodiments of the invention. It will be apparent, however, to an artisan of ordinary skill that the apparatus and methods described herein may be practiced without incorporating all aspects of the specific details described herein. In other instances, specific features, quantities, or measurements well known to those of ordinary skill in the art have not been described in detail so as not to obscure the points of innovation. Readers should note that although examples of various implementations are set forth herein, the claims, and the full scope of any equivalents, are what define the invention.

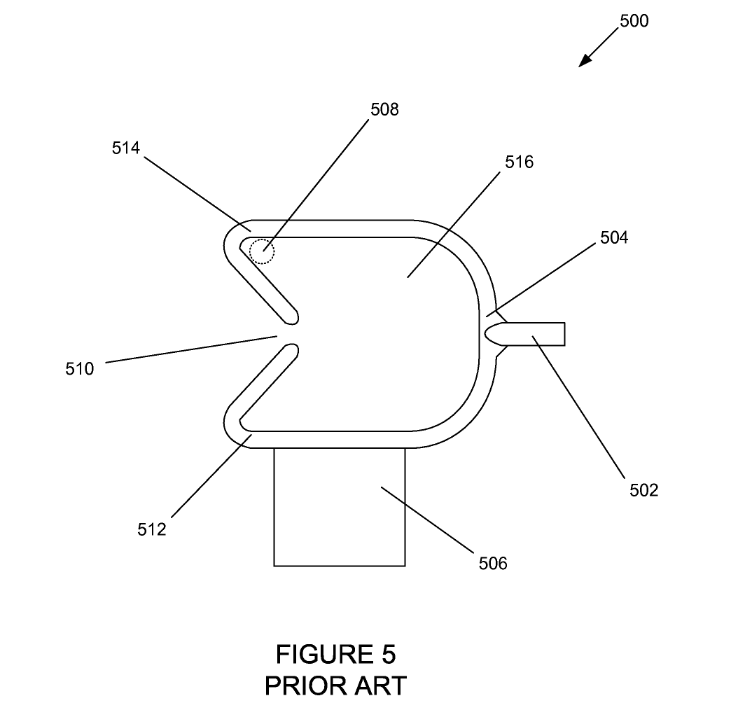

FIG. 5 illustrates a dispenser hook device in the prior art. Device 500 includes body 504. Dispenser tab 506 provides an attachment point for a dispenser. Stem 502 extends from body 504 and provides an attachment point for a placement pole configured to couple with stem 502 to aid in placement of device 500 on a support. Device 500 is attached to a support by passing its support through gate 510 into interior opening 516. When device 500 is deployed with a dispenser on a support, its support is seated at resting point 508.

Legs 512-514 extend symmetrically from body 504 at one end and come together to form gate 510 at the other end. Legs 512-514 are substantially similar in shape and flexibility. The flexibility of legs 512-514 provides ease of entry of its support into interior opening 516 through gate 510.

Device 500 is deployed in a desired area of treatment as a pest control device. The area of treatment may be a field, orchard, vineyard, or any other agricultural operation. However, forces exerted during various harvesting and maintenance operations can destroy the device or detach the device. TABLE 1 provides failure data from a strength test performed on the exemplary device hanging from a wire as when deployed on a support, such as in a vineyard. In each test case, less than 19 lbs. of force applied resulted in device failure. Device failure includes detachment of the dispenser from the device, detachment of the device from the wire, and destruction of the hook. Each of these forms of device failure render a deployed device useless in a vineyard or other areas of treatment where a harvester or other machinery is to be deployed.

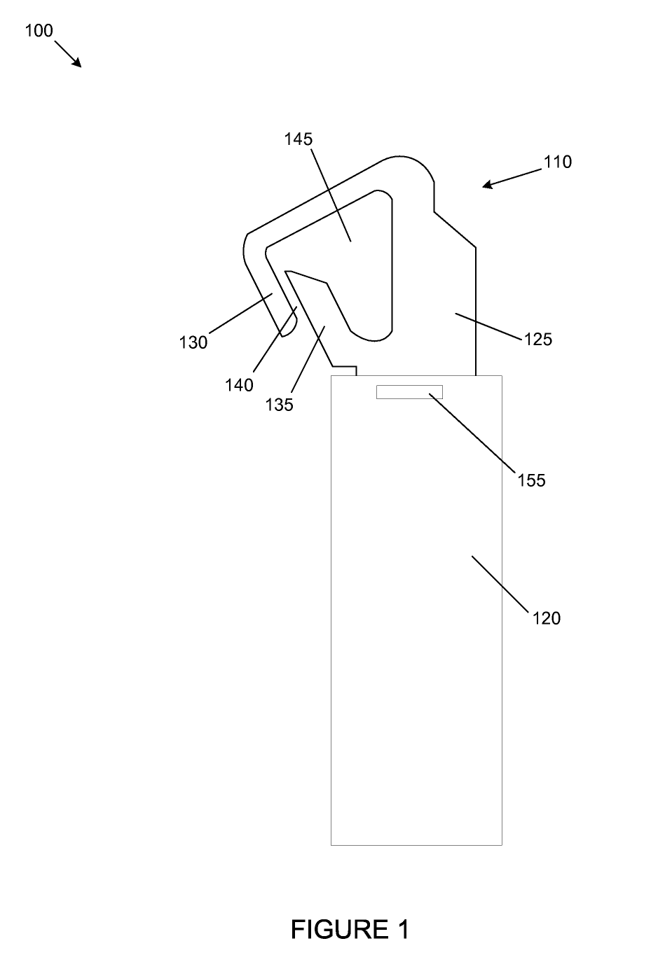

One or more embodiments of the dispenser hook described in the present application are illustrated in FIG. 1. Dispenser hook assembly 100 is shown with dispenser 120. Dispenser 120 comprises a chemical compound and a dispensing means. For example, dispenser 120 may comprise an insecticide pouch comprising a chemical compound and a permeable membrane. In one embodiment, the dispenser includes an insecticide, pheromone or other compound effective on the vine mealybug. The dispenser may however be utilized for dispersing pest control compounds against other insect pests within the desired area of treatment.

Dispenser hook 110 includes hook body 125. Outer leg 130 and inner leg 135 extend from hook body 125. Outer leg 130 and inner leg 135 are components of hook body 125 and are manufactured in one embodiment in one piece from the same material. Outer leg 130 is resiliently flexible, while inner leg 135 is more rigid. The degree of flexibility of outer leg 130 and inner leg 135 is achieved by modifying the thickness, length, shape and width of the components of hook body 125.

The material for dispenser hook 110 is generally a synthetic polymer such as acrylonitrile butadiene styrene (ABS) or polypropylene, or any other material which is capable of withstanding forces generated by the harvester. The material for dispenser hook 110 is generally resiliently flexible to enable easy entry of its support through gate 140. A resiliently flexible material also absorbs impact by flexing so that dispenser hook 110 is better able to withstand forces generated by harvesting and maintenance procedures. Hook body 125, including outer leg 130 and inner leg 135, is manufactured in one embodiment from a uniform composition through a molding process, a cutting process or any combination of manufacturing processes for manufacturing an object from a synthetic polymer.

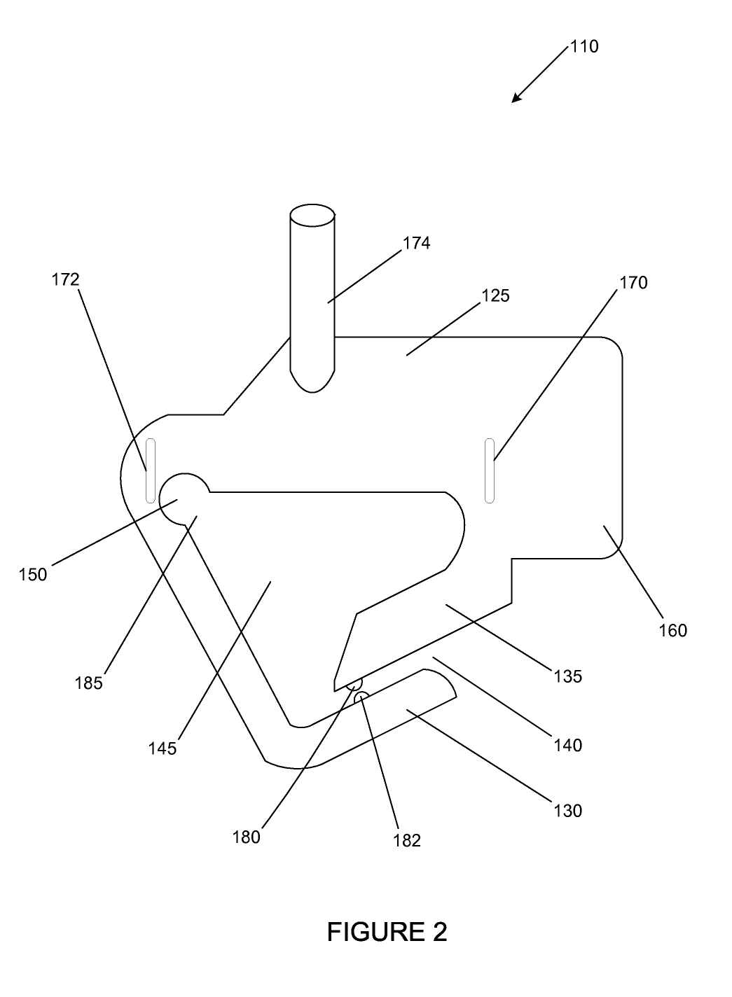

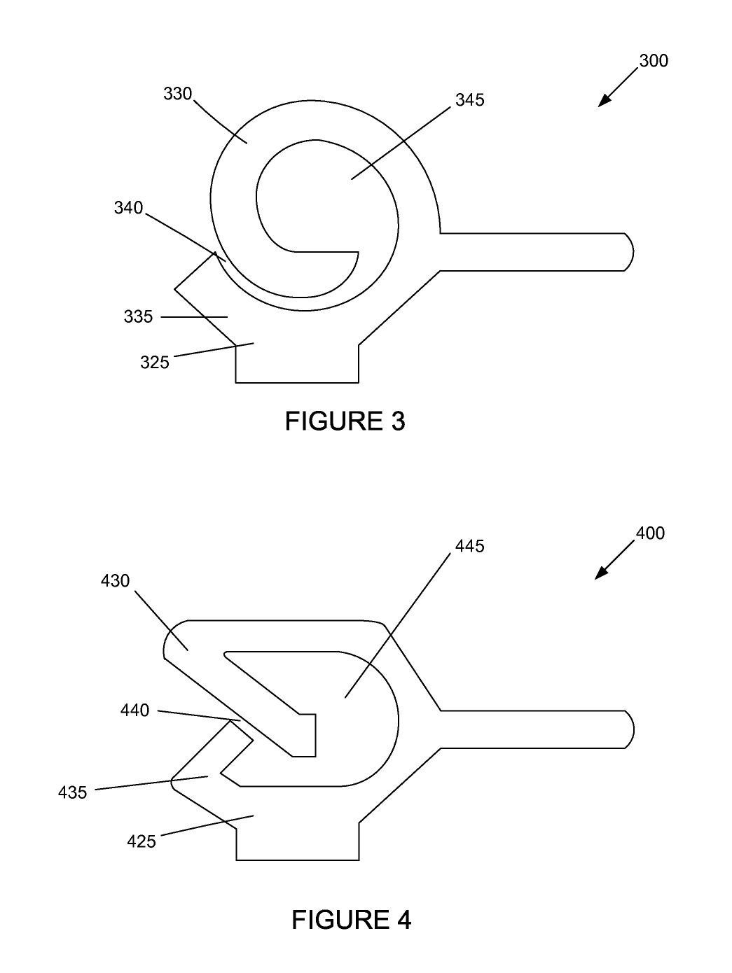

Dispenser hook 110 is configured to receive a support through gate 140. Outer leg 130 and inner leg 135 extend from hook body 125 and meet to form gate 140. An end of outer leg 130 and an end of inner leg 135 are substantially parallel. A support passes through gate 140 to interior opening 145 of dispenser hook 110. In one or more embodiments of the dispenser hook, outer leg 130 is resiliently flexed outwards to expand gate 140, allowing a support to easily pass through. After the support passes through gate 140, the resilient material returns to its starting position, closing gate 140. Outer leg 130 may be configured to flex against a support when dispenser hook 110 is pressed against a support, causing gate 140 to widen and allowing its support to pass through gate 140, thus facilitating the efficient deployment of a large number of dispenser hooks onto supports in the field. FIGS. 1-2 present embodiments of the dispenser hook with a resiliently flexible outer leg and an inner leg which is more rigid. However, other embodiments, including embodiments shown in FIGS. 3, 4 and 6A-D, may comprise a more rigid outer leg and a resiliently flexible inner leg without departing from the spirit and the scope of the invention.

At least one dispenser 120 is attached to dispenser hook 110 by attaching means 155. Attaching means 155 includes latching mechanisms, such as a fastener or a staple. In other embodiments of the dispenser hook, dispenser 120 is attached to dispenser hook 110 by other attaching means 155, such as stitching, heat, adhesive, or any other method known in the art.

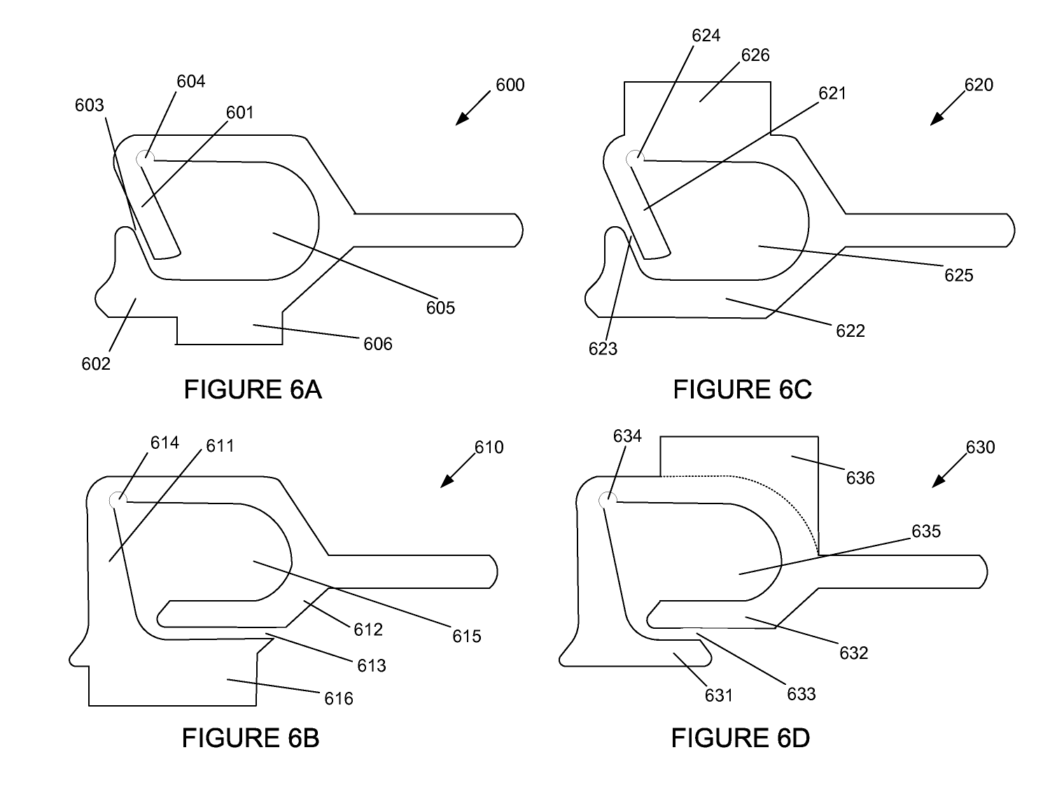

FIG. 2 illustrates additional elements useful to include in the dispenser hook in one or more embodiments. Dispenser hook 110 further comprises dispenser tab 160. Dispenser tab 160 extends outward from hook body 125. In one or more embodiments of the dispenser hook, dispenser tab 160 is configured for attaching dispenser 120. Dispenser 120 is secured to dispenser tab 160 by attaching means 155. Attaching means 155 may be separate from dispenser tab 160. Alternatively, attaching means 155 may be a component of dispenser tab 160, such as a clip or another structure configured to attach dispenser 120. Dispenser tab 160 may also include one or more recesses, holes, or other structures to accommodate an attaching means 155 for attaching dispenser 120. The dispenser tab of the dispenser hook described in the present disclosure may be disposed on any surface of the dispenser hook, including a leg of the dispenser hook, as shown in FIGS. 6A-6D.

Dispenser hook 110 further comprises one or more stacking tabs 170-174. Stacking tabs 170-174 facilitate the stacking of multiple dispenser hooks onto a machine for attaching dispensers 120 to dispenser hook 110. Stacking tabs 170-174 may be of any shape as required by the machine, such as elongated protrusions. Stacking tabs 170-174 facilitate the rapid manufacturing of a large number of dispenser hook assemblies comprising a dispenser hook 110 attached by attaching means 155 to dispenser 120.

In embodiments of the dispenser hook, outer leg 130 joins hook body 125 at support nest 150 within interior opening 145. Support nest 150 is configured to retain a support after dispenser hook 110 is deployed on a support. Dispenser hook 110 may be deployed on supports of varying sizes. In one or more embodiments, dispenser hook 100 may be deployed on supports ranging up to about 0.3″ in diameter. In one or more embodiments of the dispenser hook, support nest 150 is configured to receive a trellis wire. Typically, trellis wire ranges from 10 gauge to 12.5 gauge. In embodiments of the dispenser hook, support nest 150 is a recess or a curved projection anywhere along the inner edge of said interior opening 145. In one embodiment, after dispenser hook 110 is attached to its support, its support rests in support nest 150. The dispenser hook's support may rest in support nest 150 due to the gravitational force acting on the dispenser hook 110 and any attached dispenser 120.

In embodiments of the dispenser hook, dispenser hook 110 rotates about support nest 150 with its support acting as a pivot. Support nest 150 permits its support to rest within it such that the dispenser hook 110 undergoes reduced agitation under the forces of a harvester. For example, support nest 150 may direct forces applied into a rotational movement of dispenser hook 110 pivoting around support nest 150 in a plane. Support nest 150 may also provide a frictional damping between a support and support nest 150.

Dispenser hook 110 may be configured to require applying a small force to seat a support into support nest 150 or to remove a support from support nest 150 through nest opening 185. For example, a support may enter support nest 150 through nest opening 185 when outer leg 130 is resiliently flexed outward such that nest opening 185 is temporarily larger than the diameter of its support, allowing its support to pass nest opening 185. When outer leg 130 is returned to its original position, nest opening 185 is smaller than the diameter of its support.

Dispenser hook 110 is further provided with at least one gate guard 180-182. Gate guard 180-812 comprises a protrusion at gate 140 such that its support is guarded from exiting out of interior opening 145 when dispenser hook 110 is not flexed due to an applied mechanical stress to outer leg 130 or dispenser hook 110. Gate guard 180-182 may comprise a protrusion from inner leg 135, outer leg 130 or both.

FIG. 3 illustrates embodiments of the dispenser hook described in the application. Embodiments of dispenser hook 300 share essential features with embodiments of dispenser hook 110. Dispenser hook 300 comprises hook body 325. Hook body 325 includes resilient leg 330 and rigid leg 335. Dispenser hook 300 is configured to receive a support in interior opening 345. Its support enters interior opening 345 through gate 340. Once its support passes through gate 340, its support rests in interior opening 345. Resilient leg 330 is configured to resiliently flex to facilitate entry of its support through gate 340.

FIG. 4 illustrates embodiments of the dispenser hook described in the application. Embodiments of dispenser hook 400 share essential features with embodiments of dispenser hook 110. Dispenser hook 400 comprises hook body 425. Hook body 425 includes resilient leg 430 and rigid leg 435. Dispenser hook 400 is configured to receive a support in interior opening 445. Its support enters interior opening 445 through gate 440. Once its support passes through gate 440, its support rests in interior opening 445. Resilient leg 430 is configured to resiliently flex to facilitate entry of its support through gate 440.

FIGS. 6A-D illustrate further embodiments of the dispenser hook described in the application. In FIG. 6A, dispenser hook 600 is configured to receive a support through gate 603. A first leg 601 and a second leg 602 extend to form gate 603. A support passes through gate 603 to interior opening 605 of dispenser hook 600. First leg 601 is resiliently flexible, while second leg 602 is more rigid. An end of first leg 601 and an end of second leg 602 are substantially parallel. First leg 601 flexes outwards to expand gate 603, allowing a support to easily pass through. First leg 601 may be configured to flex against a support when dispenser hook 600 is pressed against a support, causing gate 603 to widen and allowing its support to pass through gate 603, thus facilitating the efficient deployment of a large number of dispenser hooks onto supports in the field. In embodiments of the dispenser hook, first leg 601 meets support nest 604 within interior opening 605. Support nest 604 is configured to retain a support after dispenser hook 600 is deployed on a support. Dispenser hook 600 may be configured to require applying a small force to seat a support into support nest 604 or to remove a support from support nest 604. For example, a support may enter support nest 604 when first leg 601 is resiliently flexed outward, temporarily enlarging the opening of support nest 604 and allowing its support to pass. When first leg 601 is returned to its original position, support nest 604 returns to its original configuration.

In FIG. 6B, dispenser hook 610 is configured to receive a support through gate 613. A first leg 611 and a second leg 612 extend to form gate 613. A support passes through gate 613 to interior opening 615 of dispenser hook 610. First leg 611 is resiliently flexible, while second leg 612 is more rigid. An end of first leg 611 and an end of second leg 612 are substantially parallel. First leg 611 flexes outwards to expand gate 613, allowing a support to easily pass through. First leg 611 may be configured to flex against a support when dispenser hook 610 is pressed against a support, causing gate 613 to widen and allowing its support to pass through gate 613, thus facilitating the efficient deployment of a large number of dispenser hooks onto supports in the field. In embodiments of the dispenser hook, first leg 611 meets support nest 614 within interior opening 615. Support nest 614 is configured to retain a support after dispenser hook 610 is deployed on a support. Dispenser hook 610 may be configured to require applying a small force to seat a support into support nest 614 or to remove a support from support nest 614. For example, a support may enter support nest 614 when first leg 611 is resiliently flexed outward, temporarily enlarging the opening of support nest 614 and allowing its support to pass. When first leg 611 is returned to its original position, support nest 614 returns to its original configuration.

In FIG. 6C, dispenser hook 620 is configured to receive a support through gate 623. A first leg 621 and a second leg 622 extend to form gate 623. A support passes through gate 623 to interior opening 625 of dispenser hook 620. First leg 621 is resiliently flexible, while second leg 622 is more rigid. An end of first leg 621 and an end of second leg 622 are substantially parallel. First leg 621 flexes outwards to expand gate 623, allowing a support to easily pass through. First leg 621 may be configured to flex against a support when dispenser hook 620 is pressed against a support, causing gate 623 to widen and allowing its support to pass through gate 623, thus facilitating the efficient deployment of a large number of dispenser hooks onto supports in the field. In embodiments of the dispenser hook, first leg 621 meets support nest 624 within interior opening 625. Support nest 624 is configured to retain a support after dispenser hook 620 is deployed on a support. Dispenser hook 620 may be configured to require applying a small force to seat a support into support nest 624 or to remove a support from support nest 624. For example, a support may enter support nest 614 when first leg 621 is resiliently flexed outward, temporarily enlarging the opening of support nest 624 and allowing its support to pass. When first leg 621 is returned to its original position, support nest 624 returns to its original configuration.

In FIG. 6D, dispenser hook 630 is configured to receive a support through gate 633. A first leg 631 and a second leg 632 extend to form gate 633. A support passes through gate 633 to interior opening 635 of dispenser hook 630. First leg 631 is resiliently flexible, while second leg 632 is more rigid. An end of first leg 631 and an end of second leg 632 are substantially parallel. First leg 631 flexes outwards to expand gate 633, allowing a support to easily pass through. First leg 631 may be configured to flex against a support when dispenser hook 630 is pressed against a support, causing gate 633 to widen and allowing its support to pass through gate 633, thus facilitating the efficient deployment of a large number of dispenser hooks onto supports in the field. In embodiments of the dispenser hook, first leg 631 meets support nest 634 within interior opening 635. Support nest 634 is configured to retain a support after dispenser hook 630 is deployed on a support. Dispenser hook 630 may be configured to require applying a small force to seat a support into support nest 634 or to remove a support from support nest 634. For example, a support may enter support nest 634 when first leg 631 is resiliently flexed outward, temporarily enlarging the opening of support nest 634 and allowing its support to pass. When first leg 631 is returned to its original position, support nest 634 returns to its original configuration. The dispenser tab of the dispenser hook described in the present application may be disposed on any surface of the dispenser hook, including a leg of the dispenser hook. In dispenser hook 600, dispenser tab 606 is disposed on more rigid second leg 602. In dispenser hook 610, dispenser tab 616 is disposed on the far end of resiliently flexible first leg 611. In dispenser hooks 620 and 630, dispenser tabs 626 and 636 are disposed on close ends of resiliently flexible first legs 621 and 631.

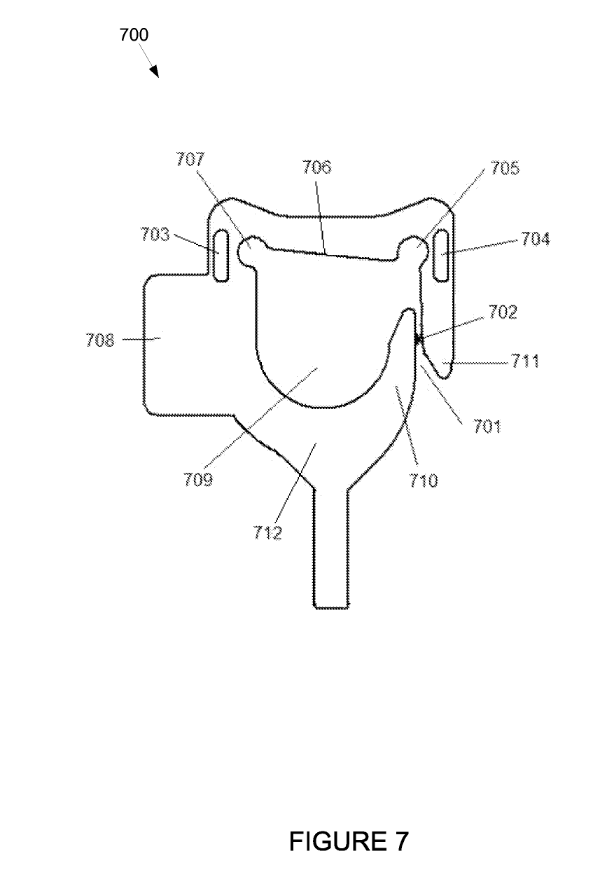

FIG. 7 illustrates further embodiments of the dispenser hook described in the application. Dispenser hook 700 includes hook body 712. Outer leg 711 and inner leg 710 extend from hook body 712. Outer leg 711 and inner leg 710 are components of hook body 712 and are manufactured in one embodiment in one piece from the same material. Outer leg 711 is resiliently flexible, while inner leg 710 is more rigid. The degree of flexibility of outer leg 711 and inner leg 710 is achieved by modifying the thickness, length, shape and width of the components of hook body 712.

The material for dispenser hook 700 is generally a synthetic polymer such as acrylonitrile butadiene styrene (ABS) or polypropylene, or any other material which is capable of withstanding forces generated by the harvester. The material for dispenser hook 700 is generally resiliently flexible to enable easy entry of its support through gate 701. A resiliently flexible material also absorbs impact by flexing so that dispenser hook 700 is better able to withstand forces generated by harvesting and maintenance procedures. Hook body 712, including outer leg 711 and inner leg 710, is manufactured in one embodiment from a uniform composition through a molding process, a cutting process or any combination of manufacturing processes for manufacturing an object from a synthetic polymer.

Dispenser hook 700 is configured to receive a support through gate 701. Outer leg 711 and inner leg 710 extend from hook body 712 and meet to form gate 701. An end of outer leg 711 and an end of inner leg 710 are substantially parallel. A support passes through gate 701 to interior opening 709 of dispenser hook 700. In one or more embodiments of the dispenser hook, outer leg 711 is resiliently flexed outwards to expand gate 701, allowing a support to easily pass through. After the support passes through gate 701, the resilient material returns to its starting position, closing gate 701. Outer leg 711 may be configured to flex against a support when dispenser hook 700 is pressed against a support, causing gate 701 to widen and allowing its support to pass through gate 701, thus facilitating the efficient deployment of a large number of dispenser hooks onto supports in the field.

Dispenser hook 700 further comprises dispenser tab 708. Dispenser tab 708 extends outward from hook body 712. In one or more embodiments of the dispenser hook, dispenser tab 708 is configured for attaching dispenser 120. Dispenser 120 is secured to dispenser tab 708 by an attaching means. The attaching means may be separate from dispenser tab 708. Alternatively, the attaching means may be a component of dispenser tab 708, such as a clip or another structure configured to attach dispenser 120. Dispenser tab 708 may also include one or more recesses, holes, or other structures to accommodate an attaching means for attaching dispenser 120. The dispenser tab of the dispenser hook described in the present disclosure may be disposed on any surface of the dispenser hook, including a leg of the dispenser hook, as shown in FIGS. 6A-6D.

Dispenser hook 700 further comprises one or more stacking tabs 703-704. Stacking tabs 703-704 facilitate the stacking of multiple dispenser hooks onto a machine for attaching dispensers 120 to dispenser hook 700. Stacking tabs 703-704 may be of any shape as required by the machine, such as elongated protrusions. Stacking tabs 703-704 facilitate the rapid manufacturing of a large number of dispenser hook assemblies comprising a dispenser hook 700 attached by an attaching means to dispenser 120.

Support nests 705 and 707 are configured to retain a support after dispenser hook 700 is deployed on a support. In one or more embodiments of the dispenser hook, support nests 705 and 707 are configured to receive a trellis wire. Typically, trellis wire ranges from 10 gauge to 12.5 gauge. In embodiments of the dispenser hook, support nests 705 and 707 are recesses or curved projections anywhere along the inner edge of said interior opening 709. In one embodiment, after dispenser hook 700 is attached to its support, its support rests in one of support nests 705 and 707. The dispenser hook's support may rest in a support nest due to the gravitational force acting on the dispenser hook 700 and any attached dispenser 120.

The presence of multiple wire nests 705 and 707 in one or more embodiments of the dispenser hook ensures that dispenser hook 700 is stabilized during installation and during a mechanical agricultural operation. Dispenser hook 700 may comprises a slope 706 in interior opening 709 between wire nest 705 and wire nest 707. In the event that installation of dispenser hook 700 onto a support does not successfully guide the support into the wire nest 705, slope 706 assists in guiding the support into wire nest 707.

In embodiments of the dispenser hook, dispenser hook 700 rotates about one of support nests 705 and 707 with its support acting as a pivot. Support nests 705 and 707 permit a support to rest within it such that the dispenser hook 700 undergoes reduced agitation under the forces of a harvester. For example, support nests 705 and 707 may direct forces applied into a rotational movement of dispenser hook 700 pivoting around the support in a plane. Support nests 705 and 707 may also provide frictional damping. Dispenser hook 700 may be configured to require applying a small force to seat a support into one of support nests 705 and 707 or to remove a support from one of support nests 705 and 707.

Dispenser hook 700 is further provided with at least one gate guard 702. Gate guard 702 comprises a protrusion at gate 701 such that its support is guarded from exiting out of interior opening 709 when dispenser hook 700 is not flexed due to an applied mechanical stress to outer leg 711 or dispenser hook 700. Gate guard 702 may comprise a protrusion from inner leg 710, outer leg 711, or both.

One or more embodiments of dispenser hook 700 are optimized for rapid deployment of a large number of hooks onto supports in an agricultural operation. For example, stacking tabs 703-704 facilitate the rapid attachment of dispensers 120 to dispenser hooks 700. Inner leg 710 may be configured to provide a surface to index support alignment before the support is passed through gate 702. The orientation of dispenser tab 708 may further facilitate deploying dispenser hook 700 onto a support by providing a natural, ergonomically efficient grasp relative to the direction of travel of dispenser hook 700 when deploying dispenser hook 700 onto a support. For example, the orientation of dispenser tab 708 may be substantially perpendicular to inner leg 710 and outer leg 711. Furthermore, the shape of the hook may be streamlined to minimize obstructions, such as protruding portions of hook body 706, which may interfere with hanging dispenser hook 700 onto a support. Furthermore, outer leg 711 may be configured without obstructions, allowing dispensers hook 700 to be hung in tight locations with limited clearance between the support and another structure, such as a trunk, vine, cordon, or another object.

While the invention herein disclosed has been described by way of examples given through the recitation of specific embodiments and applications thereof, numerous modifications and variations could be made thereto by those skilled in the art without departing from the scope of the invention set forth in the claims.

TABLE 1
Strength test

| | | Force to | |
|---|---|---|---|
| Case | Test Description | Failure (lbs) | Comments |
| 1 | Pull parallel to ground, scale hook in | No data | Test to determine valid setup/theory |
| | center of dispenser | | |
| 2 | Pull parallel to ground, scale hook in | 9.06 | Dispenser pulled off hook; recoil |
| | center of dispenser | | sent hook off wire |
| 3 | Pull parallel to ground, scale hook in | 10.13 | Hook expands to extents, dispenser |
| | center of dispenser | | pulled off hook; hook remains on |
| | | | wire |
| 4 | Pull parallel to ground, scale hook in | 8.44 | Hook expands to extents, dispenser |
| | center of dispenser | | pulled off hook; hook remains on |
| | | | wire |
| 5 | Pull parallel to ground, scale hook in | 6.13 | Spring scale hook ripped through |
| | center of dispenser | | dispenser; hook still on wire |
| 6 | 45 deg-right | 8.13 | Dispenser pulled off hook; recoil |
| | | | sent hook off wire |
| 7 | 45 deg-right | 7.63 | Dispenser pulled off hook; hook |
| | | | stayed on wire; not a realistic |
| | | | representation of applied force since |
| | | | the hook slides along the wire until |
| | | | it reaches an obstacle |
| 8 | 45 deg-up | 8.31 | Dispenser pulled off hook; recoil |
| | | | sent hook off wire |
| 9 | 45 deg-up | 10.44 | Dispenser pulled off hook; recoil |
| | | | sent hook off wire |
| 10 | 45 deg-up | 9.50 | Dispenser pulled off hook; hook |
| | | | stayed on wire |
| 11 | 45 deg-down | 11.94 | Dispenser pulled off hook; recoil |
| | | | sent hook off wire |
| 12 | 46 deg-down | 11.94 | Dispenser pulled off hook; recoil |
| | | | sent hook off wire |
| 13 | 47 deg-down | 4.50 | Dispenser pulled off hook; recoil |
| | | | sent hook off wire |
| 14 | 48 deg-down | 9.63 | Dispenser pulled off hook; recoil |
| | | | sent hook off wire |
| 15 | Spring scale hook in hook itself; pull | 17.31 | Hook broken; dispenser intact |
| | angle parallel to ground | | |
| 16 | Spring scale hook in hook itself; pull | 14.44 | Hook broken; dispenser intact |
| | angle parallel to ground | | |
| 17 | Spring scale hook in hook itself; pull | 16.75 | Hook broken; dispenser intact |
| | angle parallel to ground | | |
| 18 | Spring scale hook in Dispenser hook; pull | 15.44 | Hook expanded to extents then |
| | angle 45 deg down | | slipped off wire; dispenser intact |
| 19 | Spring scale hook in Dispenser hook; pull | 12.88 | Hook expanded to extents then |
| | angle 45 deg down | | slipped off wire; dispenser intact |
| 20 | Spring scale hook in Dispenser hook; pull | 18.81 | Hook expanded to extents then |
| | angle 45 deg down | | slipped off wire; dispenser intact |
| 21 | Spring scale hook in Dispenser hook; pull | 17.94 | Hook expanded to extents then |
| | angle 45 deg up | | slipped off wire; dispenser intact |
| 22 | Spring scale hook in Dispenser hook; pull | 15.25 | Hook broken; dispenser intact |
| | angle 45 deg up | | |
| 23 | Spring scale hook in Dispenser hook; pull | 16.63 | Hook broken; dispenser intact |
| | angle 45 deg up | | |

What is claimed is:

1. A dispenser hook comprising:
a hook body configured to couple with at least one dispenser by an attaching means;
an inner leg extending from said hook body comprising a first end; and
an outer leg and extending from said hook body comprising a second end, said outer leg being resiliently flexible,
wherein said inner leg and said outer leg form a gate to an interior opening configured to receive a support and wherein said first end and said second end are substantially parallel.

2. The dispenser hook of claim 1, further comprising at least one support nest within said interior opening, wherein said at least one support nest is positioned to permit said support to rest within said support nest.

3. The dispenser hook of claim 2, wherein said at least one support nest is a recess along an edge of said interior opening.

4. The dispenser hook of claim 2 wherein a nest opening of said at least one support nest is configured to widen when said outer leg is resiliently flexed.

5. The dispenser hook of claim, 1 wherein said at least one dispenser contains a chemical compound comprising at least one of an insecticide and a pheromone for attracting insects.

6. The dispenser hook of claim 5, wherein said chemical compound is effective on the vine mealybug.

7. The dispenser hook of claim 1, wherein said hook body further comprises a dispenser tab extending outward from said hook body, wherein said dispenser tab is configured to fixedly couple to said at least one dispenser.

8. The dispenser hook of claim 1, wherein an orientation of said dispenser tab is substantially perpendicular to said inner leg and said outer leg.

9. The dispenser hook of claim 1, wherein a maximum width of said outer leg is less than a clearance between said support and another structure.

10. The dispenser hook of claim 1, wherein said hook comprises a synthetic polymer.

11. The dispenser hook of claim 10, wherein said synthetic polymer is acrylonitrile butadiene styrene.

12. The dispenser hook of claim 10, wherein said synthetic polymer is polypropylene.

13. The dispenser hook of claim 1, wherein said outer leg is configured to flex against a support when said dispenser hook is pressed against said support.

14. The dispenser hook of claim 1, further comprising at least one gate guard, said at least one gate guard protruding from at least one of said inner leg and said outer leg such that said support is guarded from exiting out of said interior portion of said gate.

15. The dispenser hook of claim 1, wherein said support comprises trellis wire.

16. A dispenser hook comprising:
a hook body configured to fixedly couple with at least one dispenser;
a first leg comprising a first end, wherein said first leg is resiliently flexible; and
a second leg comprising a second end, said second leg being more rigid than said first leg,
wherein said first leg and said second leg extend from said hook body and form a gate to an interior opening of said hook body configured to receive a support, and wherein said first end and said second end are substantially parallel.

17. The dispenser hook of claim 16, wherein said first leg meets a support nest located in said interior opening of said hook body.

18. The dispenser hook of claim 16, wherein said support nest comprises a nest opening configured to widen when said first leg is resiliently flexed.

19. The dispenser hook of claim 16, further comprising at least one gate guard protruding from at least one of said first leg and said second leg, such that said support is guarded from exiting out of said interior portion of said gate.

20. The dispenser hook of claim 16, wherein said hook comprises a synthetic polymer.
